(19) United States
(12) Patent Application Publication
(10) Pub. No.: US 2022/0178061 A1
(43) Pub. Date: Jun. 9, 2022

(54) NON-RESPIRABLE, POLYCRYSTALLINE, ALUMINOSILICATE CERAMIC FILAMENTS, FIBERS, AND NONWOVEN MATS, AND METHODS OF MAKING AND USING THE SAME

(71) Applicant: 3M INNOVATIVE PROPERTIES COMPANY, St. Paul, MN (US)

(72) Inventors: Anne N. de Rovere, Woodbury, MN (US); Kari A. McGee, New Brighton, MN (US); Daimon K. Heller, Houlton, WI (US); William V. Chiu, Woodbury, MN (US); Petrus J. Bekker, Hastings, MN (US); Michael R. Berrigan, Oakdale, MN (US)

(21) Appl. No.: 17/651,948

(22) Filed: Feb. 22, 2022

Related U.S. Application Data
(62) Division of application No. 16/461,395, filed on May 16, 2019, now abandoned.
(60) Provisional application No. 62/424,189, filed on Nov. 18, 2016.

(51) Int. Cl. D04H 3/115; C04B 35/18; C04B 35/622; C04B 35/624; D04H 1/4209; D04H 3/004; D04H 3/03; D04H 3/105

(52) U.S. Cl. CPC D04H 3/115; C04B 35/18; C04B 35/62245; C04B 35/624; F01N 3/2853; D04H 3/004; D04H 3/03; D04H 3/105; C04B 2235/5256; D04H 1/4209

(57) ABSTRACT

A non woven web including a multiplicity of non-respirable, polycrystalline, aluminosilicate ceramic filaments entangled to form a cohesive mat, the polycrystalline, aluminosilicate ceramic filaments having an average mullite percent of at least 75 wt %. The cohesive mat preferably exhibits a compression resilience after 1,000 cycles at 900° C. when measured according to the Fatigue Test, of at least 30 kPa. Insulation articles including the cohesive mats or formed by chopping the ceramic mats into ceramic fibers, pollution control devices including the insulation articles, and methods of making the non-respirable, polycrystalline, aluminosilicate ceramic filaments and fibers, nonwoven webs, insulation articles, and pollution control devices, are also described.

### FIELD

The present disclosure relates to methods of making polycrystalline aluminosilicate ceramic filaments and nonwoven ceramic mats. More particularly, the disclosure relates to non-respirable, polycrystalline, aluminosilicate ceramic filaments, fibers, and non woven ceramic mats useful for mounting vehicle pollution control devices.

### BACKGROUND

Pollution control devices are employed on motor vehicles to control atmospheric pollution. Two types of such devices, catalytic converters and diesel particulate filters or traps, are currently in widespread use. Catalytic converters contain a catalyst, which is typically coated onto a monolithic structure mounted in the converter. The monolithic structures are typically ceramic, although metal monoliths have been used. The catalyst oxidizes carbon monoxide and hydrocarbons, and reduces the oxides of nitrogen in automobile exhaust gases to control atmospheric pollution. Diesel particulate filter's or traps are generally wall flow filters which have honeycombed monolithic structures typically made from porous crystalline ceramic material. Typically, as constructed, each type of these devices has a metal housing which holds within it a monolithic structure or element that can be metal or ceramic, and is most commonly ceramic. The ceramic monolith generally has very thin walls to provide a large amount of surface area and is fragile and susceptible to breakage. It also has a coefficient of thermal expansion generally an order of magnitude less titan the metal (usually stainless steel) housing in which it is contained.

To avoid damage to the ceramic monolith from road shock and vibration, to compensate for the thermal expansion difference, and to prevent exhaust gases from passing between the monolith and the metal housing, ceramic mat or intumescent sheet materials are often disposed between the ceramic monolith and the metal housing. The process of placing or inserting the ceramic monolith and mounting material within the metal housing is also referred to as canning and includes such processes as wrapping an intumescent sheet or ceramic mat around the monolith and inserting the wrapped monolith into the housing.

For catalytic converters to function properly, they must reach their light-off temperature. Until they do, emissions of pollutants may occur. To reduce the time required for the light-off temperature to be reached, the heat of exhaust gases going from the engine to the emission control devices should be kepi inside the exhaust system assembly. This would reduce the amount of lime that exhaust pollutants pass through the exhaust system without being catalyzed, and in turn would reduce the amount of pollutants released to the atmosphere.

It is known to insulate automotive engine exhaust pipes and catalytic mufflers using a ceramic insulation blanket or mat mounted outs ide of the exhaust pipe or muffler. The insulation material is typically a covered by a heat shield or placed in a tube-in-a-tube assembly to protect the outside of the insulation mat.

### SUMMARY

Processes for producing nonwoven webs are generally characterized as continuous filament spinning processes or discontinuous fiber blowing processes. Filament spinning processes yield continuous or substantially continuous filaments, typically in the form of rovings, which generally require further processing to be converted into a nonwoven mat. The continuous filaments in the rovings are typically chopped into shorter fiber strands that can be opened into individual fibers before being laid down (e.g. by wet-laying or air-laying) into a uniform mat, and subsequently consolidated by mechanical or chemical means. This process usually results in a somewhat uniform fiber diameter distribution, but is not a commercially viable solution for the production of poly crystalline fiber mats due to the high cost, large number of process steps, and production rate limitations inherent to the process. Air-laying may also lead to the production of undesirable respirable ceramic fibers or particulates, for example, resulting from breakage of the air-laid fibers.

Discontinuous ceramic fibers also may be produced using a fiber blowing process. In fiber blowing processes, an initially low viscosity ceramic precursor dispersion or sol is pumped through a nozzle before it is stretch and fibrillated using high speed air flow streams to form discrete fibers, which are subsequently collected to form a nonwoven green (unfired) fiber mat, which is subsequently fired at elevated temperature to form a nonwoven ceramic filament mat. The combination of low viscosity and high flow rate at the fiber-forming step typically leads to broad fiber diameter distribution and wide variation in fiber diameter variability, which docs not permit precise control of the fiber diameter for the commercial production of non-respirable, poly-crystalline, ceramic filaments or fibers, or articles including such non-respirable filaments or fibers.

Polycrystalline alumina, silica, and aluminosilicate fibers can withstand high operating temperatures, and several commercially-available products using that type of fiber in a nonwoven ceramic mat have been used in the automotive industry. Most of these mats are made using discrete (i.e., discontinuous) ceramic fibers, such as for example, Saffil LDM alumina fibers available from Unifrax (Tonawanda, N.Y.), or MLS2 and MLS3 alumina/silica fibers available from Mitsubishi Plastic, Inc. (Tokyo. Japan). Fibers having diameters less than 3 micrometers can be found in all of these commercially-available discrete ceramic Fibers and products made with them, which makes the fibers potentially respirable (e.g., breathable).

Manufactured ceramic fiber products are generally known to release airborne respirable fibers during their production and use. The upper-diameter limit for respirable fibers is generally considered to be 3 micrometers (μm). In three refractory ceramic fiber manufacturing facilities, about 90% of airborne fibers were determined to be respirable (i.e., >3 μm in diameter ), and about 95% were less than 50 μm long (see, e.g., NIOSH 2006. Criteria for a Recommended Standard: Occupational Exposure to Refractory Ceramic Fibers. National institute for Occupational Safety and Health; http://www.cdc.gov/niosh/doc/2006-1231.

Although some of these health concerns with respect to respirable aluminosilicate fibers may be mitigated by the addition of organic and inorganic binders to the nonwoven discrete aluminosilicate ceramic filaments and fiber mats formed therefrom (hence limiting the risk for the fibers to become airborne), there is a need for high performance, non-respirable, polycrystalline, aluminosilicate ceramic filaments and nonwoven webs and mats produced therefrom, that meet the requirements for non-respirable fibers (i.e., length diameter (L/D)>3:1, with a fiber diameter greater than 3 micrometers).

Briefly, in one aspect, the present disclosure describes a nonwoven web including a multiplicity of non-respirable, polycrystalline, aluminosilicate ceramic filaments entangled to form a cohesive nonwoven web. The aluminosilicate ceramic filaments have an average mullite percent of at least 75 wt. %. Preferably, the nonwoven web exhibits a compression resilience of at least 30 kPa after 1,000 cycles at 900° C. when measured according to the Fatigue Test using the open gap setting.

In another aspect, the present disclosure describes an article including the nonwoven web having a multiplicity of non-respirable, polycrystalline, aluminosilicate ceramic filaments, the article selected from a filtration article, a thermal insulation article, an acoustic insulation article, a fire protection article, a mounting mat article, a gasket article, a catalyst support article, and combinations thereof In certain exemplary embodiments, the article is incorporated in a pollution control device, which preferably is selected from a catalytic converter, a muffler, and combinations thereof. The pollution control device may be installed in a motor vehicle exhaust system of a motor vehicle selected from an automobile, a motorcycle, a truck, a boat, a submersible, or an aircraft.

In a further aspect, the present disclosure describes a method of making a nonwoven web including flowing an aqueous ceramic precursor sol through at least one orifice to produce at least one substantially continuous filament, wherein the aqueous ceramic precursor sol comprises at least one of alumina panicles or silica particles dispersed in water, and further wherein the aqueous ceramic precursor sol further comprises at least one of a hydrolysable aluminum-containing compound or a hydrolyazable silicon-containing compound; removing at least a portion of the water from the at least one substantially continuous filament to at least partially dry the at least one substantially continuous filament; passing the at least partially dried filament through an attenuator to draw the filaments to a diameter; and collecting the at least partially dried filaments as a non woven web on a collector surface

Various unexpected results and advantages may be obtained in various exemplary embodiments of the disclosure. One such advantage of exemplary embodiments of the present disclosure is that the poly crystalline, aluminosilicate ceramic filaments, webs, mats and articles made using the same are not respirable, and thus do not pose a risk of occupational health exposure. Another advantage is that the polycrystalline aluminosilicate ceramic filaments have good thermal conductivity characteristics. Still another advantage is that the polycrystalline. aluminosilicate ceramic filaments include a high proportion of mullite, thereby leading to improved filament durability and resistance to breakage which could produce undesirable respirable ceramic filament fragments of particulates. A high mullite (i.e., at least 75 wt. %, at least 80 wt. %. or even 90 wt. % or more) is also believed to improve the thermomechanical properties (e.g., resistance to thermal creep at elevated temperatures) of the ceramic filaments.

Yet another advantage in certain exemplary embodiments is that the nonwoven webs or mats have outstanding compression resilience, even after 1,000 cycles at 900° C. when measured according to the Fatigue Test described herein. Such exemplary nonwoven fibrous webs or mats thus retain their shape and thermal and/or acoustic insulation characteristics under the compression stresses encountered when used in motor vehicle insulation applications. These and other unexpected results and advantages are within the scope of the following illustrative Exemplary Embodiments and Examples.

### LISTING OF EXEMPLARY EMBODIMENTS

A. A nonwoven article, comprising:
   a plurality of non-respirable, polycrystalline, aluminosilicate ceramic filaments entangled to form a cohesive nonwoven mat, wherein the aluminosilicate ceramic filaments have an average mullite percent of at least 75 wt. %, optionally wherein the cohesive mat exhibits a compression resilience of at least 30 kPa after 1,000 cycles at 900° C. when measured according to the Fatigue Test using the open gap setting.
B. The nonwoven article of Embodiment A, wherein each of the plurality of non-respirable, polycrystalline, aluminosilicate ceramic filaments exhibits a diameter of at least 3 micrometers as determined using the Filament Diameter Measurement Procedure with electron microscopy.
C. The nonwoven article of Embodiment A or B, wherein the plurality of non-respirable. polycrystalline, aluminosilicate ceramic filaments exhibit an average diameter greater than three micrometers as determined using the Filament Diameter Measurement Procedure with electron microscopy, optionally wherein the average diameter is no greater than 20 micrometers.
D. The nonwoven article of any one of Embodiments A to C, wherein the plurality of non-respirable polycrystalline, aluminosilicate ceramic filaments exhibit a Process Capability Index (Cₚₖ) for fiber diameters greater than three micrometers of at least 1.33 as determined using the Filament Diameter Measurement Procedure with electron microscopy.
E. The nonwoven article of any one of Embodiments A to D, wherein the plurality of non-respirable polycrystalline, aluminosilicate ceramic filaments exhibit a Process Performance Index (Cₚₖ) for fiber diameters greater than three micrometers of at least 1.33 as determined using the Filament Diameter Measurement Procedure with electron microscopy.
F. The nonwoven article of any one of Embodiments A to E, wherein each of the plurality of non-respirable, polycrystalline, aluminosilicate ceramic filaments has a length of at least 3 mm.
G. The nonwoven article of any one of Embodiments A to F, wherein each of the plurality of non-respirable,

polycrystalline, aluminosilicate ceramic filaments is substantially continuous.
H. The nonwoven article of any one of Embodiments A to F, wherein the plurality of non-respirable, polycrystalline, aluminosilicate ceramic filaments have lengths of from 5 mm to at most 200 mm.
I. The nonwoven article of any one of Embodiments A to H, having a mat bulk density of from 0.05 to 0.3 g/cm³.
J. The nonwoven article of any one of Embodiments A to I, having a thickness of at least 1 mm.
K. The nonwoven article of any one of Embodiments A to J, having a thickness of at most 100 mm
L. The nonwoven article of any one of Embodiments A to K, having a basis weight of at least 50 gsm
M. The nonwoven article of any one of Embodiments A to L, having a basis weight of no more than 4,000 gsm.
N. The nonwoven article of any one of Embodiments A to M, further comprising fibers selected from the group consisting of alumina fibers, silica fibers, silicon carbide fibers, silicon nitride fibers, carbon fibers, glass fibers, metal fibers, alumina-phosphorous pentoxide fibers, alumina-boria-silica fibers, zirconia fibers, zirconia-alumina fibers, zirconia-silica fibers, and mixtures or combinations thereof.
O. The nonwoven article of any one of Embodiments A to N, wherein the plurality of non-respirable, polycrystal line, aluminosilicate ceramic filaments have an alumina to silica ratio in the range of 60:40 to 90:10 by weight.
P. The nonwoven article of any one of Embodiments A to O, further comprising a binder to bond together the plurality of non-respirable, polycrystalline, aluminosilicate ceramic filaments, optionally wherein the binder is selected from an inorganic binder, an organic binder, and combinations thereof.
Q. The nonwoven article of Embodiment P, wherein the binder is an organic binder selected from a (meth)acrylic (co)polymer, poly(vinyl) alcohol, poly(vinyl)pyrrolidone, poly(vinyl) acetate, polyolefin, polyester, and combinations thereof.
R. The nonwoven article of Embodiment P, wherein the hinder is an inorganic binder selected from silica, alumina, zirconia, kaolin clay, bentonite clay, silicate, micaceous panicles, and combinations thereof optionally wherein the binder is substantially free of silicone materials.
S. A nonwoven article of any one of Embodiments A to R, wherein the article is selected from the group consisting of a filtration article, a thermal insulation article, an acoustic insulation article, a fire protection article, a mounting mat for a vehicle component, a gasket, a catalyst support, and combinations thereof.
T. A pollution control device comprising the nonwoven article of Embodiment S.
U. The pollution control device of Embodiment T, selected from the group consisting of a catalytic convener, a muffler, and combinations thereof.
V. The pollution control device of Embodiment T or U, further comprising an intumescent layer, a reinforcing mesh, a non-intumescent insert, or a combination thereof.
W. The pollution control device of any one of Embodiments T to V, wherein the pollution control device is installed in a motor vehicle exhaust system of a motor vehicle selected from an automobile, a motorcycle, a truck, a boat, a submersible, or an aircraft.
X. A method of making a nonwoven web, comprising: flowing an aqueous ceramic precursor sol through at least one orifice to produce at least one substantially continuous filament, wherein the aqueous ceramic precursor sol comprises at least one of alumina particles or silica particles dispersed in water, and further wherein the aqueous ceramic precursor sol further comprises at least one of a hydrolysable aluminum-containing compound or a hydrolyazable silicon-containing compound;
   removing at least a portion of the water from the at least one substantially continuous filament to at least partially dry the at least one substantially continuous filament; passing the at least partially dried filament through an attenuator to draw the filaments to a diameter not less than or equal to three micrometers; and
   collecting the at least partially dried filaments as a nonwoven web on a collector surface.
Y. The method of Embodiment X, wherein the at least one orifice comprises a plurality of circular orifices positioned in a multi-orifice die in flow communication with a source of the aqueous ceramic precursor sol, optionally wherein each of the plurality of orifices has an internal diameter of from 50 to 500 micrometers.
Z. The method of any one of Embodiment X or Y, further comprising directing a stream of gas proximate the at least one substantially continuous filament to at least partially dry the at least one substantially continuous filament, optionally wherein the stream of gas is heated.
AA. The method of any one of Embodiments X to Z, wherein the aqueous ceramic precursor sol comprises aluminum chlorohydrate and silica, optionally wherein the aqueous ceramic precursor sol further comprises at least one of a water soluble (co)polymer and a defoamer.
BB. The method of any one of Embodiments X to AA, further comprising heating the nonwoven web at a temperature and for a time sufficient to convert the nonwoven web to a cohesive mat comprised of at least one non-respirable, poly crystalline, aluminosilicate ceramic filament having an average mullite percent of at least 75 wt %, wherein each of the aluminosilicate ceramic filaments has a diameter greater than or equal to three micrometers.
CC. The method of Embodiment BB, further comprising at least one of needle-punching, stitch-bonding, hydro-entangling, binder impregnation, and chopping of the cohesive mat.
DD. The method of Embodiment CC, wherein the cohesive mat is chopped to produce a plurality of discrete, non-respirable, polycrystalline, aluminosilicate ceramic fibers wherein the plurality of discrete, non-respirable, polycrystalline, aluminosilicate ceramic fibers each has a diameter of at least three micrometers as determined using the Filament Diameter Measurement Procedure with electron microscopy, the method further comprising at least one of wet-laying or air-laving at least a portion of the discrete non-respirable polycrystalline, aluminosilicate ceramic fibers to form a fibrous ceramic mat, optionally wherein the fibrous ceramic mat exhibits a compression resilience of at least 30 kPa after 1,000 cycles at 900° C. when measured according to the Fatigue Test using the open gap setting.

Various aspects and advantages of exemplary embodiments of the disclosure have been summarized. The above Summary is not intended to describe each illustrated embodiment or every implementation of the present certain exemplary embodiments of the present disclosure. The Drawings and the Detailed Description that follow more particularly exemplify certain preferred embodiments using the principles disclosed herein.

### BRIEF DESCRIPTION OF THE DRAWINGS

The present disclosure may be more completely understood in consideration of the following detailed description of various embodiments of the disclosure in connection with the accompanying figures, in which:

FIG. 1 is a cross sectional view of a mounting mat reinforced in accordance with one embodiment of the present disclosure;

FIG. 2 is a perspective view of an opened pollution control device comprising a reinforced mounting mat, according to embodiments of the present disclosure, with portions of the mat removed so as to more clearly see the aluminosilicate ceramic filaments;

In the drawings, like reference numerals indicate like elements. While the above-identified drawing, which may not be drawn to scale, sets forth various embodiments of the present disclosure, other embodiments are also contemplated, as noted in the Detailed Description. In all cases, this disclosure describes the presently disclosed disclosure by way of representation of exemplary embodiments and not by express limitations. It should be understood that numerous other modifications and embodiments can be devised by those skilled in the art, which fall within the scope and spirit of this disclosure.

### DETAILED DESCRIPTION

For the following Glossary of defined terms, these definitions shall be applied for the entire application, unless a different definition is provided in the claims or elsewhere in the specification.

### Glossary

Certain terms are used throughout the description and the claims that, while for the most part are well known, may require some explanation. It should understood that:

The term “adjoining” with reference to a particular layer means joined with or attached to another layer, in a position wherein the two layers are either next to (i.e., adjacent to) and directly contacting each other, or contiguous with each other but not in direct contact (i.e., there are one or more additional layers intervening between the layers).

By using terms of orientation such as “atop”, “on”, “over,” “covering”, “uppermost”, “underlying” and the like for the location of various elements in the disclosed coated articles, we refer to the relative position of an clement with respect to a horizontally-disposed, upwardly-facing substrate. However, unless otherwise indicated, it is not intended that the substrate or articles should have any particular orientation in space during or after manufacture.

The terms “(co)polymer” or “(co)polymers” includes homopolymers and copolymers, as well as homopolymers or copolymers that may be formed in a miscible blend, e.g., by coextrusion or by reaction, including, e.g., transesterification. The term “copolymer” includes random, block and star (e.g. dendritic) copolymers.

The term “(meth)acrylate” with respect to a monomer, oligomer or means a vinyl-functional alkyl ester formed as the reaction product of an alcohol with an acrylic or a methacrylic acid.

By using the term “separated by” to describe the position of a layer with respect to other layers, we refer to the layer as being positioned between two other layers but not necessarily contiguous to or adjacent to either layer.

The terms “about” or “approximately” with reference to a numerical value or a shape means five percent of the numerical value or property or characteristic, but expressly includes the exact numerical value. For example, a viscosity of “about” 1 Pa-sec refers to a viscosity from 0.95 to 1.05 Pa-sec, but also expressly includes a viscosity of exactly 1 Pa-sec. Similarly, a perimeter that is “substantially square” is intended to describe a geometric shape having four lateral edges in which each lateral edge has a length which is from 95% to 105% of the length of any other lateral edge, but which also includes a geometric shape in which each lateral edge has exactly the same length.

The term “non-respirable polycrystalline, aluminosilicate ceramic filament” means a fiber having a diameter determined using electron microscopy greater than three micrometers.

The term “Web basis weight” is calculated from the weight of a 10 cm×10 cm web sample.

The term “Web thickness” is measured on a 10 cm×10 cm web sample using a thickness testing gauge having a tester foot with dimensions of 5 cm×12.5 cm at an applied pressure of 150 Pa.

The term “Bulk density” is the mass per unit volume of the bulk ceramic material that makes up the web, taken from the literature.

The term “Solidity” is defined by the equation:

$$Solidity ( \% ) = \frac{[ 3.937 * Web Basis Weight ( g / {m}^{2} ) ]}{[ Web Thickness ( mils ) * Bulk Density ( g / {m}^{2} ) ]}$$

The term “substantially” with reference to a property or characteristic means that the property or characteristic is exhibited to a greater extent than the opposite of that property or characteristic is exhibited. For example, a substrate that is “substantially” transparent refers to a substrate that transmits more radiation (e.g. visible light) than it fails to transmit (e.g. absorbs and reflects). Thus, a substrate that transmits more than 50% of the visible light incident upon its surface is substantially transparent, but a substrate that transmits 50% or less of the visible light incident upon its surface is not substantially transparent.

As used in this specification and the appended embodiments, the singular forms “a”, “an”, and “the” include plural referents unless the content clearly dictates otherwise. Thus, for example, reference to fine fibers containing “a compound” includes a mixture of two or more compounds. As used in this specification and the appended embodiments, the term “or” is generally employed in its sense including “and/or” unless the content clearly dictates otherwise.

As used in this specification, the recitation of numerical ranges by endpoints includes all numbers subsumed within that range (e.g. 1 to 5 includes 1, 1.5, 2, 2.75. 3, 3.8, 4, and 5).

Unless otherwise indicated, all numbers expressing quantities or ingredients, measurement of properties and so forth used in the specification and embodiments arc to be understood as being modified in all instances by the term “about.” Accordingly, unless indicated to the contrary, the numerical parameters set forth in the foregoing specification and attached listing of embodiments can vary depending upon the desired properties sought to be obtained by those skilled in the art utilizing the teachings of the present disclosure. At the very least, and not as an attempt to limit the application of the doctrine of equivalents to the scope of the claimed embodiments, each numerical parameter should at least be construed in light of the number of reported significant digits and by applying ordinary rounding techniques.

Exemplary embodiments of the present disclosure may take on various modifications and alterations without departing from the spirit and scope of the present disclosure. Accordingly, it is to be understood that the embodiments of the present disclosure are not to be limited to the following described exemplary embodiments, but is to be controlled by the limitations set forth in the claims and any equivalents thereof.

Various exemplary embodiments of the disclosure w ill now be described with particular reference to the Drawings. Exemplary embodiments of the present disclosure may take on various modifications and alterations without departing from the spirit and scope of the disclosure. Accordingly, it is to be understood that the embodiments of the present disclosure are not to be limited to the following described exemplary embodiments, but are to be controlled by the limitations set forth in the claims and any equivalents thereof.

### Non-Respirable, Polycrystalline Aluminosilicate Ceramic Nonwoven Articles

In one exemplary embodiment, the current disclosure describes a nonwoven article, comprising a plurality of non-respirable, polycrystalline, aluminosilicate ceramic filaments entangled to form a cohesive nonwoven mat, wherein the aluminosilicate ceramic filaments have an average mullite percent of at least 75 wt. %. Preferably, the cohesive mat exhibits a compression resilience of at least 30 kPa after 1,000 cycles at 900° C. when measured according to the Fatigue Test using the open gap setting.

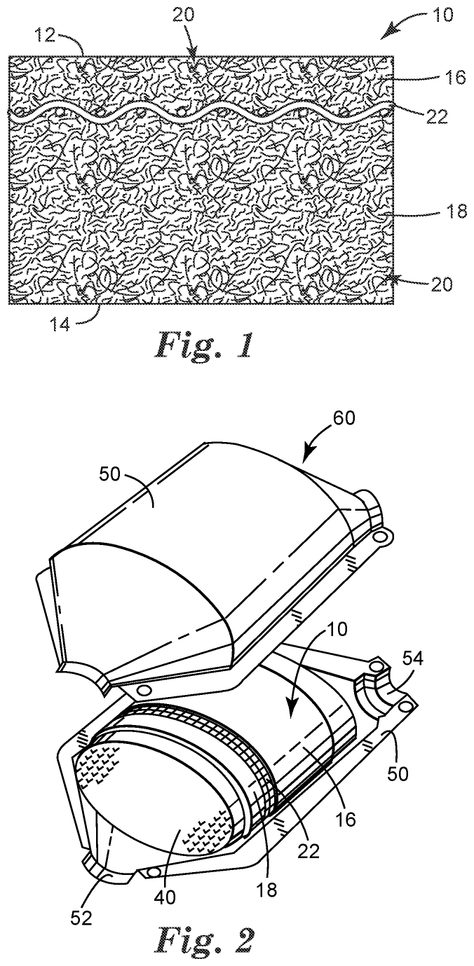

Referring now to FIG. 1, a reinforced non woven web or mat (10) according to embodiments of the present disclosure has a first major surface (12), a second major surface (14) and a thickness (i.e., the distance between surfaces (12) and (14)). The non woven web or mat (10) has at least a first layer (16) and optionally a second layer (18) and may include one or more additional layers (not shown in the drawings). Each mat layer (16) and optionally mat layer (18), comprises substantially continuous, non-respirable, polycrystalline, aluminosilicate ceramic filaments (20) have an average mullite percent of at least 75 wt. %.

In some exemplary embodiments, the non-respirable polycrystalline, aluminosilicate ceramic filaments (20) may be used in conjunction with other filaments or fibers, preferably other non-respirable filaments or fibers. Thus in certain exemplary embodiments, the reinforced mat (10) may include other filaments or fibers (not shown in the drawing), and preferably other non-respirable filaments or fibers, selected from selected from alumina fibers, silica fibers, silicon carbide fibers, silicon nitride fibers, carbon fibers, glass fibers, metal fibers, alumina-phosphorous pentoxide fibers, alumina-boria-silica fibers, zirconia fibers, zirconia-alumina fibers, zirconia-silica fibers, and mixtures or combinations thereof.

In further exemplary- embodiments, the non-respirable polycrystalline, aluminosilicate ceramic filaments (20) may be used in conjunction with other optional performance enhancing materials (e.g., intumescent materials or inserts, a non-intumescent insert, support meshes, binders, and the like). Thus, in the embodiment shown in FIG. 2, an optional reinforcing mesh (22) is show n disposed between layer (16) and optional layer (18) so as to be generally co-planer with the first major surface (12) and the second major surface (14).

Suitable optional performance enhancing materials are described, for example, in U.S. Pat. Nos. 3,001,571 and 3,916,057 (Hatch et al.); 4,305,992, 4,385,135, 5,254,416 (Unger et al.); 5,242,871 (Hashimoto et al.); 5,380,580 (Rogers et al.); 7,261,864 B2 ( Watanabe): 5,385,873 and 5,207,989 (MacNeil); and Pub. PCT App. WO 97/48889 (Sanocki et al.), the entire disclosures of each of which arc incorporated herein by reference in their entireties.

In certain exemplary embodiments, the nonwoven web or mat (10) web further comprises a binder to bond together the plurality of non-respirable polycrystalline, aluminosilicate ceramic filaments the binder is selected from an inorganic binder, an organic binder, and combinations thereof. In some such embodiments, the binder is an organic binder selected from a (meth)acrylic (co)polymer, poly(vinyl) alcohol, poly(vinyl) pyrrolidone, poly(ethylene oxide, poly(vinyl) acetate, polyolefin, polyester, and combinations thereof in other embodiments, binder is an inorganic binder selected from silica, alumina, zirconia, kaolin clay, bentonite clay, silicate, micaceous particles, and combinations thereof. Preferably, the optional binder is substantially free of silicone materials.

### Non-Respirable, Polycrystalline, Aluminosilicate Ceramic Filaments

In some exemplary embodiments of the foregoing non woven articles, each of the plurality of non-respirable, polycrystalline, aluminosilicate ceramic filaments exhibits a diameter of at least 3 micrometers (μm), 4 μm, 5 μm, 6 μm, 7 μm, 8 μm, 9 μm, or even 10 μm, as determined using the Filament Diameter Measurement Procedure with electron microscopy, as described further below.

In certain exemplary embodiments, the plurality of non-respirable, poly crystalline, aluminosilicate ceramic filaments exhibit an average diameter greater than 3 μm, 4 μm, 5 μm, 6 μm, 7 μm, 8 μm, 9 μm, or even 10 μm, as determined using the Filament Diameter Measurement Procedure with electron microscopy , as described further below.

In some such exemplary embodiments, the average diameter of the plurality of non-respirable. polycrystalline, aluminosilicate ceramic filaments is no greater than 100 μm, 7 μm, 60 μm, 50 μm, 40 μm, 30 μm, 20 μm, or even 10) μm.

In certain presently preferred embodiments, the plurality of non-respirable, polycrystalline, aluminosilicate ceramic filaments exhibit a Process Capability Index (Cₚₖ) for fiber diameters greater than three micrometers of at least 1.33 as determined using the Filament Diameter Measurement Procedure with electron microscopy, as described further below. In further exemplary embodiments, the plurality of non-respirable, polycrystalline, aluminosilicate ceramic filaments exhibit a Process Performance Index (Pₚₖ) for fiber diameters greater than three micrometers of at least 1.33 as determined using the Filament Diameter Measurement Procedure with electron microscopy, as described further below.

In further exemplary embodiments, the plurality of non-respirable, polycrystalline, aluminosilicate ceramic filaments have a length of at least 3 mm, 4 mm, 5 mm, 6 mm, 7. mm, 8 mm, 9 mm, or even 10 mm or larger. In some such exemplary embodiments, each of the plurality of non-respirable, polycrystalline, aluminosilicate ceramic filaments is substantially continuous. By substantially continuous, we mean that the filaments, while having opposing ends or termination points, nevertheless behave as continuous filaments with respect to their processing characteristics and handleability. Substantially continuous filaments typically have a length greater than 5 mm, 10 mm, 25 mm, 50 mm, 75 mm, 100 mm, 250 mm, 500 mm, 750 mm, or even longer. Substantially continuous filaments generally have a length less than 10,000 mm, 7,500 mm, 5,000 mm, 2,500 mm, 1,000 mm, or even 900 mm or shorter Thus, in certain exemplary embodiments, the plurality of non-respirable, polycrystalline, aluminosilicate ceramic filaments may have lengths of from 5 mm to at most 999 mm, 10 mm to at most 750 mm, 25 mm to at most 500 mm, or even 50 mm to at most 250 mm.

In further exemplary embodiments, the bulk density of the cohesive mat may range from 0.05 to 0.3 g/cm³, 0.06 to 0.25 g/cm³, or even 0.07 to 0.2 g/cm³. In some exemplary embodiments, the thickness of the nonwoven web and/or cohesive mat is at least 1 mm, 2 mm, 2.5 mm, 5 mm, 7.5 mm, 10 mm, 20 mm, 30 mm, 40 mm, or even 50 mm, or more. In some such exemplary embodiments, the thickness of the nonwoven web and/or cohesive mat is at most 100 mm, 90 mm, 80 mm, 70 mm, or even 60 mm or less.

In additional exemplary embodiments, the basis weight of the nonwoven web and/or cohesive mat is at least 50 g/m² (gsm), 60 gsm, 70 gsm, 80 gsm, 90 gsm, 100 gsm, or even higher.

In some such exemplary embodiments, the basis weight is no more than 4,000 gsm, 3,000 gsm, 2,000 gsm, 1,000 gsm, 750 gsm, 500 gsm, 250 gsm, or even lower.

In some exemplary embodiments, the plurality of non-respirable, polycrystalline, aluminosilicate ceramic filaments have an alumina to silica ratio in the range of 60:40 to 90:10 by weight, more preferably 60:40 to 75:25 by weight, 70:30 to 74:26 by weight, or even 72:28 to 76:24 by weight. It is currently most preferred that an alumina to silica ratio of 76:24 by weight be used.

### Articles Including Non-Respirable, Polycrystalline, Aluminosilicate Ceramic Nonwoven Mats

In another aspect, the present disclosure describes an article including the foregoing nonwoven aluminosilicate ceramic webs web having a multiplicity of non-respirable, polycrystalline, aluminosilicate ceramic filaments. In some such embodiments, the article may be selected from a nitration article, a thermal insulation article, an acoustic insulation article, a fire protection article, a mounting mat article, a gasket article, a catalyst support article, and combinations thereof, in certain exemplary embodiments, the article is incorporated in a pollution control device.

In certain such exemplary embodiments, the disclosure provides a pollution control device comprising the non-respirable, polycrystalline aluminosilicate ceramic filaments, nonwoven articles, webs and mats described above. In some such exemplary embodiments, the pollution control device is selected from the group consisting of a catalytic converter, a muffler, and combinations thereof.

Referring now to FIG. 2, a pollution control device 60 (e.g., a catalytic converter and/or an exhaust filter), according to the present disclosure, can comprise a housing 50, a pollution control element 40 (e.g., a catalytic element and/or fitter) mounted inside of the housing 50, and a mourning mat 10 like those described herein sandwiched between so as to mount the element 40 within the housing 50. The housing 50 is typically made of a metal such as, for example stainless steel, and includes an inlet 52 and an outlet 54 to allow exhaust gases from an internal combustion engine to pass through the device 60 The element 40 is typically a thin walled monolithic structure that is relatively fragile. The mat 10 provides protection for the clement 40 from both thermal and mechanical (e.g., vibrational) related damage.

It can be desirable for an optional mesh 22 to be positioned close to the surface 12 of the mat 10 (i.e., for the layer 16 to be relatively thinner than the layer 18). For example, with a mat 10 having a total weight of about 1600 g/m², and the netting 22 having a weight in the range of from about 80 to about 160 g/m², it can be desirable for the layer 16 to have a weight in the range of from about 40 to about 800 g/m². Put another way, it can be desirable for the layer 16 to comprise in the range of from 3% to 10% of the total weight of the mat 10.

Thus, in some exemplary embodiments, the pollution control device further comprises an intumescent layer, a reinforcing mesh, a non-intumescent insert, or a combination thereof. Suitable intumescent layers, reinforcing meshes, and non-intumescent inserts are described, for example, in U.S. Pat. Nos. 3,001,571 and 3,916,057 (Hatch et al); 4,305,992. 4,385,135, 5,254,416 (Langer et ah); 5,242,871 (Hashimoto et al.); 5,380,580 (Rogers et al.); 7,261,864 B2 (Watanabe); 5,385,873 and 5,207,989 (MacNeil); and Pub PCT App. WO 97/48889 (Sanocki et al.), the entire disclosures of each of which were previously incorporated herein by reference in their entireties.

In some such exemplary embodiments, the pollution control device may be installed in a motor vehicle exhaust system of a motor vehicle selected from an automobile, a motorcycle, a truck, a boat, a submersible, or an aircraft.

### Methods of Making Non-Respirable Polycrystalline Ceramic Fibers and Nonwoven Mats

In another aspect, the disclosure describes a method of making a nonwoven web, comprising:
flowing an aqueous ceramic precursor sol through at least one orifice to produce at least one substantially continuous filament, wherein the aqueous ceramic precursor sol comprises at least one of alumina particles or silica particles dispersed in water, and further wherein the aqueous ceramic precursor sol further comprises at least one of a hydrolysable aluminum-containing compound or a hydrolyazable silicon-containing compound;
removing at least a portion of the water from the at least one substantially continuous filament to at least partially dry the at least one substantially continuous filament; passing the at least partially dried filament through an attenuator to draw the filaments to a diameter not less than or equal to three micrometers; and
collecting the at least partially dried filaments as a nonwoven web on a collector surface.

In some such exemplary methods, the at least one orifice comprises a plurality of circular orifices positioned in a multi-orifice die in flow communication with a source of the aqueous ceramic precursor sol. Optionally, each of the plurality of orifices has an internal diameter of from 50 to 500 μm, 75 to 400 μm, or even 100 to 250 μm.

In some presently-preferred embodiments, the method further comprises directing a stream of gas proximate the at least one substantially continuous filament to at least partially dry the at least one substantially continuous filament. It is presently-prefer red that the stream of gas is heated. Generally, the stream of gas should be heated to a temperature of at least 50° C., 75° C., 100° C., 125° C., 150° C., 200° C., 250° C. or even higher temperature

A suitable apparatus and exemplary orifices useful in practicing various embodiments of the presently disclosed method of producing the at least one substantially continuous filament are described U.S. Pat. No. 6,607,624, the entire disclosure of which is incorporated herein by reference in its entirety.

In one particularly-preferred embodiment, the nonwoven web is heated (e.g., fired) at a temperature and for a time sufficient to convert the nonwoven web to a cohesive mat comprised of at least one non-respirable polycrystalline, aluminosilicate ceramic filament having an average mullite percent of at least 75 wt. %. In general, the nonwoven web should be heated to a firing temperature of at least 500° C., 750° C., 1,000° C., 1,250° C., 1,500° C., or even higher temperature. Higher firing temperatures may result in shorter firing times, and conversely, longer firing times may permit use of lower firing temperatures. In general, the firing time should be at least 2 hours. 4 hours, 5 hours, 7.5 hours, 10 hours, or even longer. In general, the firing time should be less than 24 hours, less than 20 hours, less than 15 hours, less than 12 hours, or even 10 hours. Suitable firing furnaces (i.e., kilns) are well known to those skilled in the art, for example, the continuous kilns manufactured by HED International, Inc. (Ringoes, N.J.).

The aqueous ceramic precursor sol comprises at least one of alumina particles or silica particles dispersed in water. Suitable alumina and silica sols are described, for example, in U.S. Pat. Nos. 5,380,580 (Rogers et al.); 8,124,022 (Howorth et al.); and further wherein the aqueous ceramic precursor sol further comprises at least one of a hydrolysable aluminum-containing compound or a hydrolyazable silicon-containing compound. Suitable ceramic precursor sols are described in U.S. Pat. Nos. 3,760,049 ( Borer et al.) and 4,954,462 ( Wood et al.), the disclosures of which are incorporated herein by reference in their entireties.

The aqueous ceramic precursor sol further comprises at least one of a hydrolysable aluminum-containing compound or a hydrolyazable silicon-containing compound. Suitable hydrolysable aluminum-containing and silicon-containing compounds are described, for example, in U.S. Pat. No. 5,917,075 (Wolter); and U.S. Pub. Pat. App. No. 2002/0098142 (Brasch et al), the disclosures of which are incorporated herein by reference in their entireties. In certain presently-preferred embodiments, the aqueous ceramic precursor sol comprises aluminum chlorohydrate and dispersed silica particles.

Optionally, the aqueous ceramic precursor sol further comprises at least one of a water soluble (co)polymer and a defoamer. Any suitable water soluble (copolymer may be used; however, poly(vinyl) alcohol, poly(vinyl) alcohol-co-poly(vinyl) acetate copolymers, poly(vinyl) pyrrolidone, poly(ethylene oxide), and pol (ethylene oxide)-co-(propylene oxide) copolymers, have been found particularly suitable. Any suitable defoamer may be used; however, when medium degrees of hydrolysis (e.g., 50-90% poly(vinyl) acetate) poly(vinyl) alcohol-co-poly(vinyl) acetate copolymers are used, defoamers based on long chain alcohols like 1-octanol, and polyol esters such as the FOAM-A-TAC series of antifoams available from Enterprise Specialty Products Inc. (Laurens, S.C.), for example, FOAM-A-TAC 402, 407, and 425.

### Optional Processing Steps

Certain optional processing steps may be found advantageous in practicing various exemplary embodiments of the present disclosure. For example, the cohesive ceramic mats may be subjected to at least one of needle-punching, stitch-bonding, hydro-entangling, binder impregnation, and chopping of the cohesive mat into discret fibers.

Thus, in one currently contemplated exemplary embodiment, the cohesive mat may be chopped to produce a plurality of discrete, non-respirable, polycrystalline, aluminosilicate ceramic fibers wherein the plurality of discrete, non-respirable, polycrystalline, aluminosilicate ceramic filaments each has a diameter of at least three micrometers as determined using the Filament Diameter Measurement Procedure with electron microscopy. The resulting chopped fibers may then be further processed, for example, using at least one of wet-laying or air-laying, to form a fibrous ceramic mat include discrete, non-respirable, aluminosilicate ceramic fibers. Preferably, the resulting fibrous ceramic mat exhibits a compression resilience of at least 30 kPa alter 1,000 cycles at 900° C. when measured according to the Fatigue Test using the open gap setting.

Embodiments of fibrous nonwoven mounting mats described herein can be made, for example, by feeding chopped, individualized fibers (e.g., about 2.5 cm to about 5 cm in length) into a lickerin roll equipped with pins such as that available from Laroche (Cours la ville, France) and/or conventional web-forming machines commercially available, for example, under the trade designation “RANDO WEBBER” from Rando Machine Corp. (Macedon, N.Y.); “DAN WEB” from ScanWeb Co. (Denmark), wherein the fibers are drawn onto a wire screen or mesh belt (e.g., a metal or nylon belt). If a “DAN WEB”-type web-forming machine is used, the fibers are preferably individualized using a hammer mill and then a blower. To facilitate ease of handling of the mat, the mat can be formed on or placed on a scrim.

Embodiments of fibrous nonwoven mounting mats described herein can be also made, for example, using conventional wet-forming or textile carding. For wet forming processes, the fiber length is often from about 0.5 cm to about 6 cm.

In some exemplary embodiments, particularly with wet forming processes, a binder may be advantageously used to facilitate formation of the mat. In some embodiments, nonwoven mats described herein comprise not greater than 10 (in some embodiments not greater than 4, 3, 2, 1, 0.75, 0.5, 0.25, or even not greater than 0.1) percent by weight binder, based on the total weight of the mat, while others contain no binder.

Optionally, some embodiments of fibrous nonwoven mounting mat described herein are needle-punched (i.e., where there is physical entanglement of fibers provided by multiple full or partial (in some embodiments, full) penetration of the mat, for example, by barbed needles). The nonwoven mat can be needle punched using a conventional needle punching apparatus (e.g., a needle puncher commercially available, for example, under the trade designation “DILO” from Dilo Gmbh (Germany), with barbed needles commercially available, for example, from Foster Needle Company. Inc. (Manitowoc, Wis.) or Groz-Beckert Group (Germany), to provide a needle-punched, nonwoven mat.

Needle punching, which provides entanglement of the fibers, typically involves compressing the mat and then punching and drawing barbed needles through the mat. The efficacy of the physical entanglement of the fibers during needle punching is generally improved when the polymeric and/or bi-component organic fibers previously mentioned are included in the mat construction. The improved entanglement can further increase tensile strength and improve handling of the nonwoven mat. The optimum number of needle punches per area of mat will vary depending on the particular application.

Typically, the nonwoven mat is needle punched to provide about 5 to about 60 needle punches/cm² (in some embodiments, about 10 to about 20 needle punches/cm². Optionally, some embodiments of mounting mat described herein are stitchbonded using conventional techniques (see e.g., U.S. Pat. No. 4,181,514 (Lefkowitz, et al.), the disclosure of which is incorporated herein by reference for its teaching of stitchbonding non woven mats). Typically, the mat is stitchbonded with organic thread. A thin layer of an organic or inorganic sheet material can be placed on either or both sides of the mat during stitchbonding to prevent or minimize the threads from cutting through the mat. If it is desirable for the stitching thread to not decompose in use, an inorganic thread, (e.g., ceramic or metal (such as stainless steel) can be used. The spacing of the stitches is usually about 3 mm to about 30 mm so that the fibers are uniformly compressed throughout the entire area of the mat.

The operation of the present disclosure will be further described with regard to the following detailed examples. These examples are offered to further illustrate the various specific and preferred embodiments and techniques. It should be understood, however, that many variations and modifications may be made while remaining within the scope of the present disclosure.

### EXAMPLES

These Examples are merely for illustrative purposes and are not meant to be overly limiting on the scope of the appended claims. Notwithstanding that the numerical ranges and parameters setting forth the broad scope of the present disclosure are approximations, the numerical values set forth in the specific examples are reported as precisely as possible. Any numerical value, however, inherently contains certain errors necessarily resulting from the standard deviation found in their respective testing measurements. At the very least, and not as an attempt to limit the application of the doctrine of equivalents to the scope of the claims, each numerical parameter should at least be construed in light of the number of reported significant digits and by applying ordinary rounding techniques.

### Summary of Materials

Unless otherwise noted, all parts, percentages, ratios, etc. in the Examples and the rest of the specification are by weight. Solvents and other reagents used may be obtained from Sigma-Aldrich Chemical Company (Milwaukee, Wis.) unless otherwise noted. In addition, Table 1 provides abbreviations and a source for all materials used in the Examples below:

TABLE 1
Materials

| Name | Description | Source |
|---|---|---|
| DelPAC XG | Al₂(OH)₅Cl, aluminum | USALCO, LLC, |
| | chlorohydrate (ACH, | Baltimore, MD |
| | 22.17% Al₂O₃) | |
| Nalco 1034A | 35.60% Aqueous Colloidal | Nalco Corp., Naperville, IL |
| | Silica Sol | |
| Selvol 523 | Polyvinyl Alcohol | Sekisui Specialty Chemical, |
| | | LLC, Dallas, TX |

### Test Methods

The following test methods have been used in evaluating some of the Examples of the present disclosure.

### Mullite Content Measurement Procedure:

Powder x-ray diffraction was used to measure mullite content using an internal standard method. Titanium oxide, rutile (99.99%), from Alfa Aesar (Ward Hill, Mass.) was used as the internal standard and uniformly mixed into sample powders at 10 wt %. The integrated intensities of the 16.4 degree 20 mullite peak and the 26.4 degree 20 rutile peak were measured. Control samples with known mullite content were analyzed to establish a calibration curve relating mullite content to the relative integrated intensity of the mullite and rutile peaks. The mullite content of example materials was determined by measuring the relative integrated intensity of the mullite and rutile peaks and then reading the mullite percentage from the calibration curve. Powders were analyzed in triplicate with a Rigaku MiniFlex 600 diffractometer (Tokyo, Japan) using Cu K_{α} radiation.

### Filament of Fiber Diameter Measurement Procedure:

Images of cross-sections of exemplary mats (i.e., handsheets) of the present disclosure were collected using a Phenom Pure Scanning Electron Microscope from PhenomWorld (Eindhoven, The Netherlands), at a magnification of at least 500X. At least 80 filaments or fibers were measured per sample using Fibermetric software from PhenomWorld.

The following Filament or Fiber Diameter statistics were determined using Minitab statistical analysis software available from Minitab, Inc. (State College, Pa.);

Cₚₖ (Process Capability Index) is a statistical measure of process capability: it measures how close a process is running to its specification limits, relative to the natural variability of the process. Cₚₖ is defined as:

$${C}_{pk} = \frac{\overline{x} - LSL}{3 σ}$$

wherein χ̅ is the mean filament or fiber diameter, LSL is the lower specification limit (3 μm), and σ is the sample standard deviation for the fiber diameter.

Pₚₖ (Process Performance Index) is an estimate of the process capability of a process during its initial set-up, before it has been brought into a state of statistical control. Pₚₖ is defined as:

$${p}_{pk} = min \frac{[ USL - \overline{x}}{3 σ} \cdot \frac{\overline{x} - LSL ]}{3 σ}$$

wherein χ̅ is the mean filament or fiber diameter, USL is the upper specification limit (3 μm), LSL is the lower specification limit (3 μm), and σ is the sample standard deviation for the population of fiber diameters.

PPM (Part Per Million) is a measurement used to measure quality performance. One PPM means one (defect or event) in a million or 1/1,000,000.

Cₚₖ and Pₚₖ are quality indexes used to evaluate products and process quality. To ensure conformance to a specification, product characteristics with a Cₚₖ less than 1.33 (4 sigma) typically must be inspected to remove defective products, which is undesirable in that it adds to the cost and complexity of a manufacturing operation.

### Fatigue Test (Mat Compression Measurements for 1,000 Cyclic at 900° C.):

Fiber mat samples were fatigue tested in a furnace at 900° C. by placing the samples in the variable gap between two quartz pucks attached to a uniaxial load cell located outside the furnace, then cycling the gap between the pucks from an expanded or “open gap” mat position to a compressed or “closed gap” mat position The test generally follows the procedure outlined in the section titled “Heated Cyclic Compression Test” in column 10, lines 6-27 of commonly owned U.S. Pat. Nos. 5,736,109; 7,704,459 and 8,007,732, all three references being incorporated herein by reference in their entireties.

A 1 inch (2.54 cm) or 2 inch (5.08 cm) diameter test sample was cut from the polycrystalline, aluminosilicate ceramic filament mats. Samples were weighed and their weight was recorded. Based on sample weight, the open gap opening (target density 0.36 g/cc) and closed gap opening (target density 0.40 g/cc) were calculated using the following equation: density (g/cc)=sample basis weight (g/cm²) gap (cm).

Summary of the Test Protocol

A Material Test System (MTS) Model 812.05 from MTS Systems Corporation (Eden Prairie, Minn.) or equivalent, with 0-9 kN load cell and build-in height measuring device was used, along with a furnace capable of heating the entire sample to 900° C.

Sample Preparation Conditions
1. Die cut either a 1″ or 2 inch diameter=50.8 mm+/−0.2 mm
2. Weigh the sample on a scale accurate to 0.01 grams and record the mass
3. Calculate required gaps based on sample weight and required mount densities

Test Conditions
1. Place sample between quartz discs and close to the required closed gap setting.
2. Close furnace and start ramp to a temperature of 900° C. (one hour)
3. Once 900° C. temperature is reached dwell for five minutes before cycling begins
4. After five minute dwell at 900° C., start cycling of the gap between closed gap setting and open gap setting.
5. Cycle time is 27 seconds. One cycle is defined as the time it takes for the gap to cycle from closed gap through open gap and back to closed gap. Gap continually changes between closed and open gaps without dwell lime at either during test.
6. Record open gap pressure after 1000 cycles.

Data Acquisition (Load and Peak/Valley)
1. Starts at the onset of the cycling segment and ends once the cycling segment completes. The load data acquisition is segmented into two parts. The first part records data every cycle for the first hundred cycles, while the second pan records data every hundred cycles for the remainder of die cycling segment.
2. The peak/valley acquisition records data when the axial stroke signal reaches a peak or valley (i.e. minimum and maximum gap)
3. Signals Recorded:
   a. Axial Count
   b. Axial Load
   c. Axial Stroke
   d. Actual Temperature
4. The remaining resistance pressure (in kPa) of the mat sample against the quartz pucks with the test device in the open gap position after 1000 cycles at 900° C. is reported in the table below as “Open Ok.”

### Sol Making Methods

Aluminum chlorohydrate (ACH) of general formula Al₂(OH)₅Cl sold under the trade designation DelPAC XG was obtained from USALCO, LLC, of Baltimore. Md. The colloidal silica used was Nalco 1034A from Nalco of Naperville, Ill. Polyvinylalcohol (PVA) in this report was partially hydrolyzed (87-89%) and high molecular weight, sold as Selvol 523 available front Sekisui Specialty Chemical of Dallas, Tex. The PVA solution was dissolved in deionized water by heating to 90-95° C. and had 0.027% n-octanol added. The concentration of organic additive in sol in all cases is a weight % of the additive with respect to alumina.

Sol Making Method 1 (for ACH Sol 72/28 Al₂O₃:SiO₂, 10% PVA)

Acid stabilized colloidal silica (Nalco 1034A, 35.60% silica), 2663.09 g, was diluted to 20% silica with water (2077.21 g) and then either added drop wise via addition funnel or by pouring slowly to 10,996.25 g aluminum chlorohydrate (ACH, 22.17% Al₂O₃). A 5% poly(vinyl) alcohol (high MW, 88-89% hydrolyzed) solution with 0.027% n-octanol added (5419.00 g) was added via pouring to the stirring ACH/SiO₂ mixture. Additional n-octanol (˜0.80 g) was added as an anti-foaming agent before filtration. The solution was filtered through a 0.45 um glass fiber filter. The solution was then concentrated at a pressure of 10-20 mbar in a 40° C. bath.

Four batches w ere concentrated on four consecutive days. The viscosities of batches 1-4 were roughly 47,000, 87,000, 12,000, and 57,000 cP after one day and were all combined together to give a sol of about 35,000 cP.

Sol Making Method 2 (for ACH Sol 76/24 Al₂O₃:SiO₂, 15% PVA)

Acid stabilized colloidal silica (Nalco 1034A, 34.90% silica), 156.94 g, was diluted to 20% silica with water (123.13 g) and then added dropwise via addition funnel to 800.00 g aluminum chlorohydrate (ACH, 22.17% Al₂O₃) A 5% poly(vinyl) alcohol (high MW, 88-89% hydrolyzed) solution with 0.027% n-octanol added (˜625.99 g) was added via pouring to the stirring ACH/SiO₂ mixture. Additional n-octanol (˜0.10 g) was added as an anti-foaming agent before filtration. The solution was filtered through a 0.45 um glass liber filter. The solution was then concentrated at a pressure of 20 mbar in a 40° C. bath. The viscosity was roughly 47,000 cP alter concentration.

### Fiber Spinning Methods

Fibrous nonwoven green (i.e., unfired) fiber webs were prepared by delivering an inorganic sol gel solution through a spinneret assembly with multiple orifices, to form a stream of filaments, drying and drawing the filaments as they move down, and then intercepting the stream of filaments on a porous collector. The filaments deposited on the collector as a mass of fibers (bulk or mat) were fired as formed, and after post-processing. Fired fibers could also be post-processed Post-processes include but are not limited to needle tacking, chopping, wet-laying (i.e., making into a water based slurry), dry-laying (e.g., air-laying or use of a carding machine such as a Rando-Webber (available from Rando Machine Corporation, Macedon, N.Y.), and the like.

### Fiber Spinning Method 1

Green fiber webs were produced using a spinneret with orifices 5 mil (0.13 mm) in diameter, and a length to diameter (L/D) ratio of 2/1. Sol was placed in a pressure pot, and pressurized with compressed air at about 50 psi (0.34 MPa.) Sol was delivered to the spinneret via a metering pump (1.108 cc/rev), available from Zenith Pumps (Monroe, N.C.). Drying equipment delivered heated air perpendicular to fiber direction. The drying zone was about 24 in (61 cm) in length. Green fibers were drawn down by an air venturi apparatus placed about 7 inches (18 cm) below the drying zone. The fiber drawing device was a set of two parallel air knives.

The porous collector belt was positioned about 25 inches (64 cm) below the bottom of the attenuator. The green fibers in examples 2, 4 and 6 were then fired into a final inorganic suite (e.g. alumino silicate fiber). For examples 1, 3 and 5, multiple layers were stacked up and needled together before being fired.

### Fiber Spinning Method 2

Fiberization was performed inside of a 0.9×0.9×2.4 m spinning lower with acrylic panels (3M Fabrication Services, St. Paul, Minn.) using a 40-hole stainless steel die (Kasen Nozzle, Osaka, Japan) with a 6 mil (0.15 mm) orifice diameter, L/D=1, and a hole spacing of 0.18 in. (4,6 mm). Sol was fed using compressed nitrogen (Oxygen Service Company, St. Paul, Minn.) at a feed pressure of 40 psi (276 kPa). Air diffusers with a 6×12 in. (15×30 cm) outlet (3M Fabrication Services) were positioned downstream from the die to provide dry heated air to the extruded filaments. Air to the diffusers were provided by two 0.5 HP (0.37 kW) regenerative blowers (Gast Manufacturing, Inc., Benton Harbor, Mich.), with a total air How rate of 27 SCFM. (0.76 m³/min.).

The air was heated with two 2 kW air heaters (Osram-Sylvania, Wilmington, Mass.) to 150° C. (measured after the heater outlet). A 5 in. (13 cm) wide air attenuator with two parallel plates (3M Fabrication Services) was positioned 32 cm downstream from the air diffuser. The plate gap was set to 0.25 in. (6.4 mm). Air flow into the attenuator was controlled with a rotameter (King Instrument Company, Garden Grove, Calif.) to a flow rate of 9 SCFM (0.25 m³/min.). After the attenuator, the fibers were dispersed onto a 12 in. (30 cm) diameter vacuum collector drum mounted 38 cm below the attenuator. Exhaust flow through the drum was provided with a 3 HP (2.2 kW) regenerative blower (Mapro International s.p.A., Nova Milanese MB, Italy).

### Green Filler Firing Method:

Firing of green fibers can be considered to comprise two main segments. The first is a lower temperature pre-fire (burnout) segment in which organics are removed and inorganic phases begin to form. The second is a high temperature crystallization and sintering segment w here the fibers density and high temperature crystalline phases form. The two segments can be performed separately (e.g.,, a pre-fire followed by cooling to room temperature before sintering) or sequentially in a continuous process (e.g., a pre-fire followed immediately by sintering without allow the material to cool). Herein, the pre-fire segment is considered to occur up to 850° C. and can be successfully performed in as few as 20 minutes or over several hours. Successfully pre-fired fibers are microstructurally uniform, optically transparent and easily handled without breakage or dusting. Typically, the fibers are exposed to water vapor during the pre-fire to improve process consistency but this is not strictly necessary to attain the characteristics described herein. A wide range of water vapor pressures, from 40-450 torr (5,300-60,000 Pa), are useful. Pre-fired fibers can be sintered by insertion into a box furnace held at a predetermined temperature. The densification of the aluminosilicate ceramic filament and its final phase composition are determined by the sintering time and temperature. One set of useful time/temperature combinations for sintering range from 1250° C. to 1370° C. for 10 minutes, most preferably from 1270° C. to 1330° C., but a variety of time/temperature combinations can be used to produce nearly identical results.

### Ceramic Fiber Mats or Webs

### Small Handsheet Preparation Method:

Tap water (900 ml) and 6 grams (g) of inorganic fibers prepared as described above were added to a blender. The blender was operated on low speed for 10 to 15 seconds. The resultant slurry was rinsed into a mixing container equipped with a paddle mixer using 100 ml of tap water. The diluted slurry was mixed at medium speed to keep solids suspended. Ethylene-vinyl acetate terpolymer latex (obtained under the trade designation “AIRFLEX 600BP” (0.38 g, 55 percent by weight solids) from Wacker Chemical Corporation of Munich, Germany was added. Three drops of flocculent (MP 9307C from Mid South Chemical Co. Inc., of Ringgold, La.) was added. The paddle mixer was removed and the slurry was poured into an 80 mm diameter sheet former and drained. A few sheets of blotter paper w ere placed on the surface of the drained sheet and pressed down by hand to remove excess water. The sheet was then dried at 140° C. in a forced air oven for 1 hour.

### Large Handsheet Preparation Method:

Tap water (3000 ml) and 40 grams (g) of inorganic fibers were added to a blender. The blender was operated on low speed for 10 to 15 seconds. The resultant slurry was rinsed into a mixing container equipped with a paddle mixer using 2000 ml of tap water. The diluted slurry was mixed at medium speed to keep solids suspended. Ethylene-vinyl acetate terpolymer latex (obtained under the trade designation “AIRFLEX 600BP” (2.5 g. 55 percent by weight solids) from Wacker Chemical Corporation (Munich, Germany). State) was added. The flocculent MP 9307C from Mid South Chemical Co. Inc., (Ringgold, La.) was added in the amount of0.25 g. The paddle mixer was removed and the slurry was poured into an 8 inch by 8 inch (20 cm×20 cm) square sheet former and drained.

A few sheets of blotter paper were placed on the surface of the drained sheet and pressed down by hand to remove excess water. Then, the sheet was pressed between blotter papers at a surface pressure of 20 psi for five minutes. The sheet was then dried at 140° C. in a forced air oven for 1 hour.

### Comparative Example 1

Needled Maftec (MLS2) blanket from Mitsubishi Plastic Inc. Tokyo. Japan) at 1100 gsm basis weight (no organic content).

### Comparative Example 2

Handsheet mat was produced by pulping MLS2 blanket from MPI for 15 see following the large hand-sheet procedure detailed above.

### Comparative Example 3

Handsheet mat was produced by pulping Saffil 3D+ fiber from Unifrax LLC, Tonawanda, N.Y., for 12 sec following the large hand-sheet procedure detailed in the large hand-sheet preparation section.

### Example 1

A green fiber nonwoven web was produced using the Sol Making Method (72/28 alumina/silica) and Fiber Spinning Method 1 described above. The green fiber web was produced with a 160 holes die with 5 mil orifice size (0.30 inch (7.6 mm) spacing), and L/D of 2/1. Sol was fed through die using Zenith pump at 20 rpm (1.168 cc/rev), for a theoretical sol rate of 0.233 g/hole/min. Sol was dried with heated air (58° C.) blown at 40 fpm (0.20 m/s) perpendicular to the fiber motion. Sol was attenuated into green fibers by air knifes separated by 0.50 inches (1.3 cm.)

Several layers of green fiber webs were needled together using a custom-made needle board with 15×25×40×3 CB needles from Foster Needle Co. Inc of Manitowoc, Wis. at inch (1.9 cm) square spacing.

Needled green fiber webs were pre-fired by first heating to 750° C. over 50 minutes and then to 850° C. over 40 minutes. Approximately 75 torr of water vapor was introduced when furnace temperatures reached about 130° C. Final heat treatment of the needled green fiber webs was performed by inserting them for 10 minutes into a furnace preheated to approximately 1300° C.

### Example 2

A green fiber nonwoven web was produced using the same spinning process and conditions as Example 1. Bulk green fiber webs were fired following the firing profile provided above. A hand-sheet mat was produced using the small hand-sheet mat method and pulping the fibers for 10 sec. The hand-sheet mat was fired according to the procedure in Example 1.

### Example 3

A green fiber nonwoven web was produced using the same spinning process and conditions as Example 1. The green fiber web was produced with a 160 holes die with 5 mil orifice size (0.30″ spacing), and L/D of 2/1. Sol was fed through die using Zenith pump at 20 rpm (1.168 cc/rev), for a theoretical sol rate of 0.28 g/hole min. Sol was dried with heated air (61° C.) blown at 40 fpm perpendicular to the fiber motion. Sol was attenuated into green fibers by air knifes separated by 0.50″.

Several layers of green fiber webs were needled together using a custom-made needle board with 15×25×40×3 CB needles front Foster Needle Co. Inc. of Manitowoc, Wis. at ¾ square spacing. Needled green fiber webs were fired according to the procedure in Example 1.

### Example 4

A green fiber non woven web was produced using the same spinning process and conditions as Example 3. Bulk green fiber webs were fired following the firing profile provided above. A hand-sheet mat was produced using the small hand-sheet mat method and pulping the fibers for 10 sec. The hand-sheet mat was fired according to the procedure in Example 1.

### Example 5

A green fiber nonwoven web was produced using the same spinning process and conditions as Example 1. The green fiber web was produced with a 105 holes die with 5 mil orifice size (0.30″ spacing), and L/D of 2/1. Sol was fed through die using Zenith pump at 16 rpm (1.168 cc/rev), for a theoretical sol rate of 0.285 g/hole/min. Sol was dried with heated air (75C) blown at 42 fpm perpendicular to the fiber motion. Sol was attenuated into green fibers by air knifes separated by 0.45″.

Several layers of green fiber webs were needled together using a custom-made needle board with 15×25×40×3 CB needles from Foster Needle Co. Inc. of Manitowoc, Wis. at % inch (1.9 cm) square spacing.

Needled green fiber webs were fired following the firing profile provided above. The 1000 cycle test was performed following test method described above. Needled green fiber webs were fired according to the procedure in Example 1.

### Example 6

A green fiber non woven web was produced using the same spinning process and conditions as Example 1. Bulk green fiber webs were fired following the firing profile provided above. A hand-sheet mat was produced using the small hand-sheet mat method and pulping the fibers for 10 sec.

### Example 7

A green fiber nonwoven web was produced using the Sol Making Method (76/24 alumina/silica) and Fiber Spinning Method 2 described above. The bulk green fiber web was fired following the firing profile according to the procedure of Example 1, except a sintering temperature of 1285° C. was used.

A hand-sheet mat was produced using the small hand-sheet mat method and pulping the fibers for 10 sec.

### Example 8

Green fiber was spun using the spinning process described above with Sol Making Method 2 (76/24) and Fiber Spinning Method 2. The bulk green fiber web was Fired following the firing profile according to the procedure of Example 1, except a sintering temperature of 1315° C. was used.

A hand-sheet (mat) was produced using the small hand-sheet mat method and pulping the fibers for 10 sec.

### Example 9

Green fiber was spun using the spinning process described above with Sol Making Method 2 (76/24) and Fiber Spinning Method 2. The bulk green fiber web was fired following the firing profile according to the procedure of Example 1, except a sintering temperature of 1345° C. was used.

A hand-sheet mat was produced using the small hand-sheet mat method and pulping the fibers for 10 sec.

For each of the Comparative Examples and Examples, the Mullite Content determined according to the Mullite Content Measurement Procedure; the Filament Diameter Statistics (i.e., average diameter, Cₚₖ and Pₚₖ of Fibers having diameters greater than 3 μm, the fraction (PPM) of Fibers having diameters less than 3 μm, and the Minimum Diameter) determined according to the Filament Diameter Measurement Procedure, and the remaining resistance pressure (Open Clk) determined according to the Fatigue Test, are reported in Table 2 below.

TABLE 2

| | | Fiber diameter measurements | | | | | | |
|---|---|---|---|---|---|---|---|---|
| | | | Avg | | | | Min. | |
| | | Fiber | Dia | Cpk | Ppk | PPM | dia | Open C1k |
| Example | Alumina/Silica | Count | um | <3 um | <3 um | <3 um | um | kPa |
| Comparative | 72/28 | 425 | 5.68 | 0.76 | 0.55 | 49,170 | 0.90 | 40 |
| Example 1 | | | | | | | | |
| Comparative | 72/28 | 425 | 5.68 | 0.76 | 0.55 | 49,170 | 0.90 | 33 |
| Example 2 | | | | | | | | |
| Comparative | 96/4 | 91 | 6.25 | 1.07 | 1.06 | 748 | 3.20 | 43 |
| Example 3 | | | | | | | | |
| Example 1 | 72/28 | | | | | | | 57 |
| Example 2 | 72/28 | 422 | 8.63 | 2.06 | 1.86 | 0.01 | 6.10 | 48 |
| Example 3 | 72/28 | | | | | | | 49 |
| Example 4 | 72/28 | 250 | 9.05 | 2.46 | 2.04 | 0.00 | 6.80 | 42 |
| Example 5 | 72/28 | | | | | | | 48 |
| Example 6 | 72/28 | 494 | 11.07 | 1.69 | 1.55 | 1.58 | 4.90 | 42 |
| Example 7 | 76/24 | 184 | 8.12 | 1.82 | 1.86 | 0.01 | 6.01 | 39 |
| Example 8 | 76/24 | 145 | 12.8 | 2.4 | 2.23 | 0.00 | 4.90 | 39 |
| Example 9 | 76/24 | 81 | 8.35 | 1.99 | 2.11 | 0.00 | 6.50 | 45 |

Reference throughout this specification to “one embodiment,” “certain embodiments,” “one or more embodiments” or “an embodiment,” whether or not including the term “exemplary” preceding the term “embodiment,” means that a particular feature, structure, material, or characteristic described in connection with the embodiment is included in at least one embodiment of the certain exemplary embodiments of the present disclosure. Thus, the appearances of the phrases such as “in one or more embodiments,” “in certain embodiments,” “in one embodiment” or “in an embodiment” in various places throughout this specification are not necessarily referring to the same embodiment of the certain exemplary embodiments of the present disclosure. Furthermore, the particular features, structures, materials, or characteristics may be combined in any suitable manner in one or more embodiments.

While the specification has described in detail certain exemplary embodiments, it will be appreciated that those skilled in the art, upon attaining an understanding of the foregoing, may readily conceive of alterations to, variations of, and equivalents to these embodiments. Accordingly, it should be understood that this disclosure is not to be unduly limited to the illustrative embodiments set forth hereinabove. In particular, as used herein, the recitation of numerical ranges by endpoints is intended to include all numbers subsumed within that range (e.g., 1 to 5 includes 1, 1.5, 2, 2.75, 3, 3.80, 4, and 5). In addition, all numbers used herein are assumed to be modified by the term “about.”

Furthermore, all publications and patents referenced herein are incorporated by reference in their entirety to the same extent as if each individual publication or patent was specifically and individually indicated to be incorporated by reference. Various exemplary embodiments have been described. These and other embodiments are within the scope of the following claims.

1-9. (canceled)

10. A method of making a nonwoven web, comprising:
flowing an aqueous ceramic precursor sol through at least one orifice to produce at least one substantially continuous filament, wherein the aqueous ceramic precursor sol comprises at least one of alumina particles or silica particles dispersed in water, and further wherein the aqueous ceramic precursor sol further comprises at least one of a hydrolysable aluminum-containing compound or a hydrolyazable silicon-containing compound;
removing at least a portion of the water from the at least one substantially continuous filament to at least partially dry the at least one substantially continuous filament;
passing the at least partially dried filament through an attenuator to draw the filaments to a diameter not less than or equal to three micrometers; and
collecting the at least partially dried filaments as a nonwoven web on a collector surface.

11. The method of claim 10, further comprising directing a stream of gas proximate the at least one substantially continuous filament to at least partially dry the at least one substantially continuous filament, optionally wherein the stream of gas is heated.

12. The method of claim 10, wherein the aqueous ceramic precursor sol comprises aluminum chlorohydrate and silica, optionally wherein the aqueous ceramic precursor sol further comprises at least one of a water soluble (co)polymer and a defoamer.

13. The method of claim 10, further comprising heating the nonwoven web at a temperature and for a time sufficient to convert the nonwoven web to a cohesive mat comprised of at least one non-respirable, polycrystalline, aluminosilicate ceramic filament having an average mullite percent of at least 75 wt. %, wherein each of the aluminosilicate ceramic filaments has a diameter greater than or equal to three micrometers.

14. The method of claim 13, further comprising at least one of needle-punching, stitch-bonding, hydro-entangling, binder impregnation, and chopping of the cohesive mat.

15. The method of claim 14, wherein the cohesive mat is chopped to produce a plurality of discrete, non-respirable, polycrystalline, aluminosilicate ceramic fibers wherein the plurality of discrete, non-respirable, polycrystalline, aluminosilicate ceramic filaments each has a diameter of at least three micrometers as determined using the Filament Diameter Measurement Procedure with electron microscopy, the method further comprising at least one of wet-laying or air-laying at least a portion of the discrete non-respirable polycrystalline, aluminosilicate ceramic fibers to form a fibrous ceramic mat, optionally wherein the fibrous ceramic mat exhibits a compression resilience of at least 30 kPa after 1,000 cycles at 900° C. when measured according to the Fatigue Test using the open gap setting.
